(19) United States
(12) Patent Application Publication
(10) Pub. No.: US 2021/0271803 A1
(43) Pub. Date: Sep. 2, 2021

(54) SYSTEM FOR DYNAMIC EDITING

(71) Applicants: Arthur F. Seymour, Deerfield, IL (US); Joseph P. Seymour, Deerfield, IL (US); James P. Seymour, Deerfield, IL (US)

(72) Inventors: Arthur F. Seymour, Deerfield, IL (US); Joseph P. Seymour, Deerfield, IL (US); James P. Seymour, Deerfield, IL (US)

(21) Appl. No.: 17/174,333

(22) Filed: Feb. 11, 2021

Related U.S. Application Data
(60) Provisional application No. 62/983,627, filed on Feb. 29, 2020.

(51) Int. Cl. G06F 40/134; G06K 7/14; G06F 21/31

(52) U.S. Cl. CPC G06F 40/134; G06F 21/31; G06K 7/1417

(57) ABSTRACT

An interactive book, or other material, that may be edited by the general public is provided. The interactive material may also hold imbedded links to dedicated Internet websites. The present interactive book allows for multiple people to be able to constantly update and track information contained in the book.

### REFERENCE TO RELATED APPLICATIONS

This application claims priority to U.S. Provisional Application No. 62/983,627 which was filed on Feb. 29, 2020, the entire contents of which are incorporated by reference herein.

### BACKGROUND OF THE INVENTION

Books and other printed materials are typically composed of many pages (made of papyrus, parchment, vellum, or paper) bound together and generally protected by a durable cover. The technical term for this physical arrangement is codex (in the plural, codices). A single sheet in a codex is a leaf, and each side of a leaf is a page.

Most books are of a length that requires time to compose and cost to produce. Google® has estimated that as of 2010, approximately 130,000,000 distinct titles had been published. In some wealthier nations, the sale of printed books has decreased because of the increased usage of electronic or “e-books” which are available on computers, tablets, phones, etc.

In the 2000s, due to the rise in availability of affordable handheld computing devices, the opportunity to share texts through electronic means known as the “e-book” grew in popularity. To read an e-book one must have a device such as the Sony Reader®, Barnes & Noble Nook®, Kobo eReader®, or the Amazon Kindle®. Since e-books exist on the Internet, they may be edited easily. Further, it is easy for the publisher to update information contained in the book so that new consumers purchasing or otherwise downloading the information receive the most current information and edits. Any past printings from this source, however, will remain unchanged.

There are many reasons people buy e-books including, usually lower prices, easy transportation of numerous titles, instant access to the book, increased comfort (one may buy from home or on the go with mobile devices) and a larger selection of titles. With e-books, electronic bookmarks make referencing easier, and e-book readers may allow the user to annotate pages. Both fiction and non-fiction books come in e-book formats.

The ownership of a paper book is fairly straightforward, but generally subject to legal restrictions on renting or copying for books that have not yet fallen into the public domain. The purchaser of an e-book's digital file generally also has some restrictions and/or limitations such as, for example, restrictions due to digital rights management provisions, copyright issues, or limitations based on the publisher's business failing or even the user's credit card expiring.

A QR bar code (quick response code hereafter QR code) in or on a book, may contain data for a locator, identifier or tracker, for example, that points to a website or application for additional information pertaining to the book (e.g. the price of the book). A QR code is a type of 2D bar code that is often used to provide access to information through an Internet device with a camera. The locator, identifier or tracker that the QR code points to initially will be hereafter termed the Dedicated Internet Website. To visit different Dedicated Internet Websites requires different QR codes. There are many devices that allow displaying different content through Internet links, as described above, for e-books. The printed book or e-book, however, does not allow the reader to change the link in the e-book without changing the e-book itself. Various types of editing in existence today are shown here below.

U.S. Pat. No. 9,524,036 to Cassidy discloses Various types of content which may be displayed through an interface of a computing device. Portions of this content, such as words or alphanumeric characters, can have a visual identifier displayed proximate those portions. The identifiers can indicate the availability of additional content, such as one or more alternative spellings or corrections, links to additional information, alternative views, and links to contact information for a name in an address book. In one example, a default viewing orientation of the computing device can be determined for a user viewing the content on the interface. Upon detecting a rotation of the computing device, a banner or other graphical element is displayed for each of the displayed portions that are associated with a visual identifier on the interface. Accordingly, a user can select one of those elements to receive the additional information.

Further, U.S. Pat. No. 9,465,504 to Jurgens discloses a system for automated collaborative behavior analysis using temporal motifs. The system receives an input documents and change log files of a collaborative media, where the documents are continuously edited by multiple authors and where edits are recorded in the change log files, such as Wikipedia. A type of editing behavior by the authors of a given document is identified, and the edits made to the document are analyzed. The system reports how the authors interacted in a collaboration process, resulting in a set of reported author interactions. From the set of reported author interactions, a set of author interactions that are most and least significant in the collaboration process are identified. Then, based on the set of identified author interactions, future effects on documents of the collaborative media are estimated.

Still further, U.S. Pat. No. 10,402,061 to Kohlmeier discloses an assisted content authoring productivity tool which can provide a set of content related to at least one topic determined from a user's expression of intent. The content can include topics that are not obviously related to the user's topic, but identified from indirect cluster connections found in a graph model of information such as, but not limited to, an online encyclopedia like Wikipedia. A document can be populated with topic anchors so a user can return to or have generated a set of content related to a particular topic. The topic anchor can include a graphical user interface including a topic exploration object that, when selected, initiates a command to request information related to that topic.

All of the above patents require a physical change to the original document in order to change the link and/or add the name of the editor or reader that made that change.

In accordance with a first aspect of one embodiment of the present interactive e-book, the present e-book, or imprinted material, may have a QR code printed that links to a Dedicated Internet Website when scanned by a bar code reader. The Dedicated Internet Website then may redirect the input to other Internet websites appropriate to the printed material with no change to the original material.

In accordance with a second aspect of the embodiment, the present interactive e-book may have links imbedded in it which may send the reader to the Dedicated Internet Website when reader clicks on the imbedded area. The Dedicated Internet Website may then redirect the input to other Internet websites appropriate to the printed material. In accordance with a third aspect of the present interactive e-book, a person may contact the controller of the Dedicated Internet Website and request a change or edit to the redirection of a particular link from a QR code or imbedded link in an e-book. The request may be to correct and/or add to the content of the original work.

In accordance with a fourth aspect of the present interactive e-book, any change to redirect from one Internet website to a different Internet website may also be recorded and accessed through a separate QR code, hereafter called the Dynamic Editors QR code, or imbedded link, hereafter call the Dynamic Editors imbedded link, in the original work. This recorded data may show date of change, person that requested the change, and the original Internet website that was previously redirected to.

In accordance with a fifth aspect of the present interactive e-book, all books printed previous to the requested change, being printed now, or to be printed in the future with the same QR codes or imbedded links, will contain in their QR codes or their imbedded links the new edited change.

In accordance with a sixth aspect of the present interactive e-book, all books printed previous to the change, being printed now or to be printed in the future with the same QR codes or imbedded links, will contain in their Dynamic Editors QR code the name of the person that made the edit. They may also contain the date of the edit and the data of other previous links that have been changed.

In accordance with a seventh aspect of the present interactive e-book, all e-books purchased previous to the change, being purchased now or to be purchased in the future with the same code links, will contain in their Dynamic Editors imbedded link the name of the person that made the edit. They may also contain the date of the edit and the data of other previous links that have been changed.

In accordance with an eighth aspect of the present interactive e-book, the Dedicated Internet Website may also include choices by the user to be redirected to different Internet websites.

### BRIEF DESCRIPTION OF THE DRAWINGS

Illustrative embodiments of the present invention are described herein with reference to the accompanying drawings, in which:

FIG. 1 illustrates a block diagram of a Reader Using Dynamic Editing System.

FIG. 2 illustrates a block diagram of the how Dynamic Editing works.

FIG. 3 illustrates a block diagram of Dynamic Editing System with Reader Choices.

FIG. 4 is an actual working QR code for Dynamic Editors in a book.

FIG. 5 are examples of imbedded links as they may appear in an e-book.

### DETAILED DESCRIPTION OF THE PREFERRED EMBODIMENTS

An interactive book, such as an e-book, with QR codes is provided. The interactive e-book may have QR codes. In addition to QR codes, the interactive e-book may also hold imbedded links to a Dedicated Internet Website. The present interactive e-book allows for multiple people to be able to constantly update information contained in the e-book.

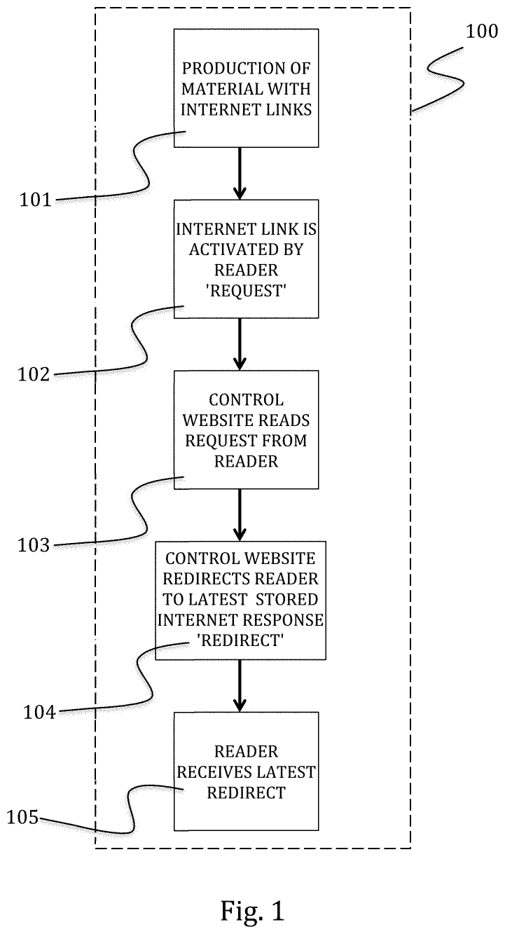

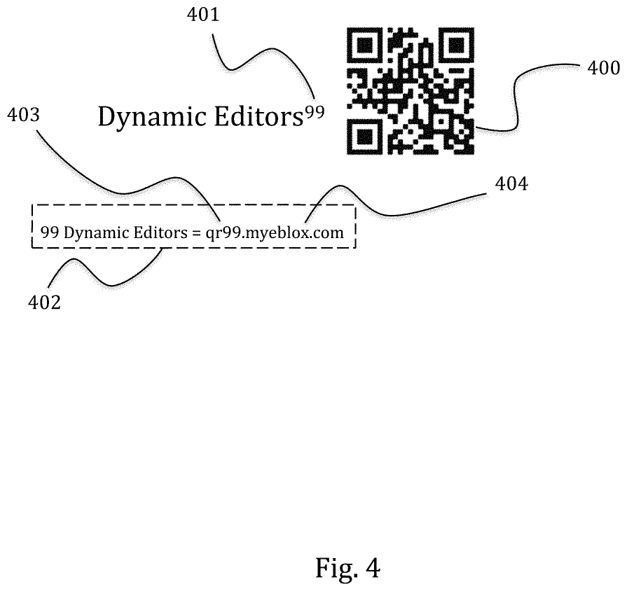

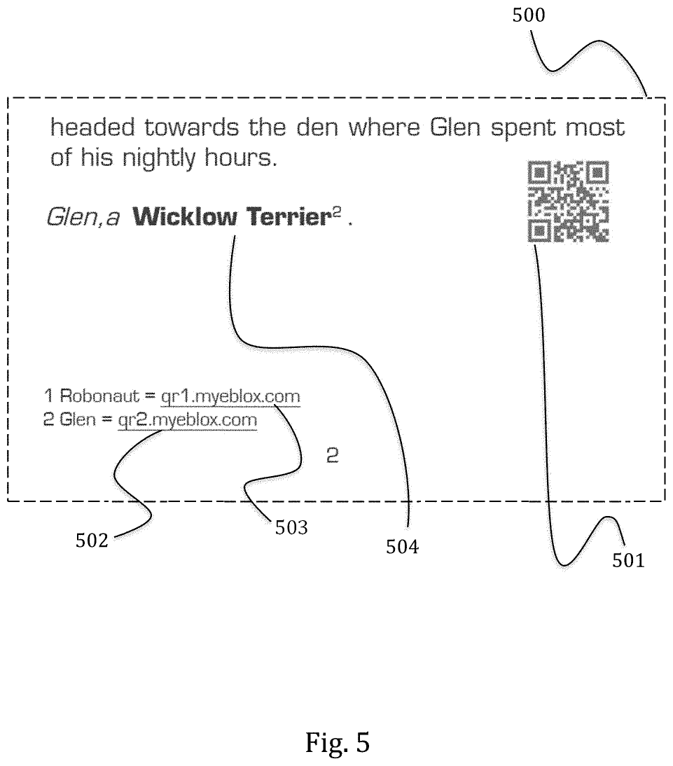

Referring first to FIG. 1 a block diagram of the Dynamic Editing System 100 is provided for the interactive book. In a first step, the publisher of the interactive book may produce or create a plurality of material/information with QR codes and/or imbedded Internet Links 101. While reading the book, a reader of the interactive book may selectively activate 102 desired information (FIG. 5 501, 502, 503, or FIG. 4 400) in the QR codes and/or imbedded Internet Links 101. Such action by the reader is hereafter referred to as a “Request” by the reader. All Request are directed to a single Control Website 103, which reads the Request ID (FIG. 5 502, 503). The Request ID consists of a Link ID 403 and a Control Website 404. The Link ID 403 is preferably the alphanumeric group after an “equal sign” and before the first period in the footnote 402, in this case qr99. The Control Website 404 is preferably the alphanumeric group after the first period in the footnote 402, in this case myeblox.com 404. The Request ID redirects the Reader to the latest stored Internet response 104, which hereafter shall be referred to as the “Redirect”. The Reader, therefore, always receives the latest and most current edits in response to his/her Request, regardless of when he/she received his/her interactive book.

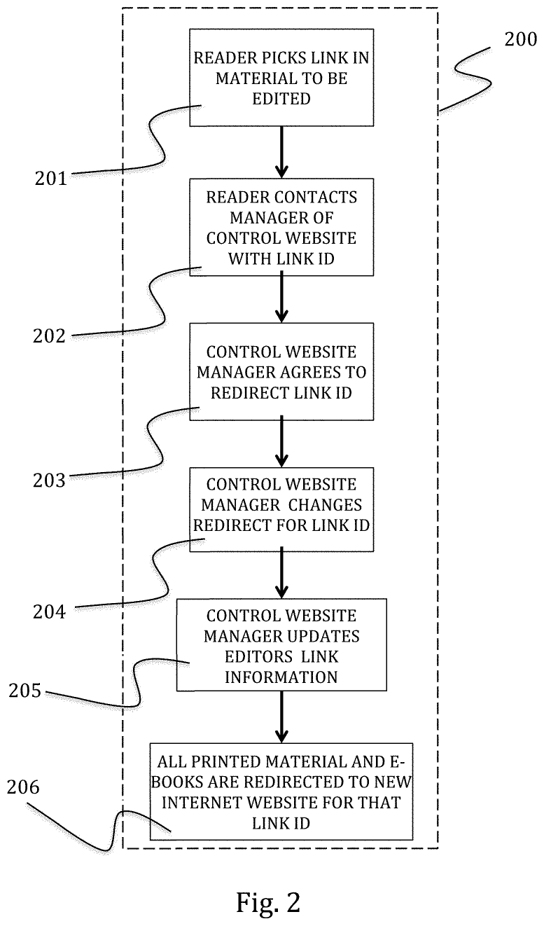

FIG. 2 is a block diagram of how redirects in QR codes or imbedded Internet links 101 may be changed 200 by the Reader of the interactive book in one embodiment. For example, the Reader may first pick a QR code link 400, 501 or imbedded link 502, 503. In printed materials 101 with only QR codes 400, no imbedded links 502, 503 would be available, but a footnote 401, 402 similar to the imbedded links 502, 503 may be on every page with a QR code 400. All footnotes 401, 402 for a QR code link 400 may contain the unique “Link ID” 403. The Reader may contact the manager 202 (or “control manager”) of the Control Website 103 and may propose a better Internet website for the Link ID 403. After review of the issue, the Control Website 103 manager may then agree 203 to change the Redirect 104 to a new Internet website or may decline the request. The Control Website 103 manager may then change 204 the Redirect 104 to the new Internet website. The Reader has now become a Dynamic Editor and the Control Website 103 manager may update the information access by the Dynamic Editors QR code and Dynamic Editors imbedded link 205. All printed material and e-books 101 that use the same QR codes or imbedded links will now be redirected to the new Link ID 403 and receive the latest information 206. In an embodiment, the control manager may be required to enter a password in order to edit or otherwise control any website.

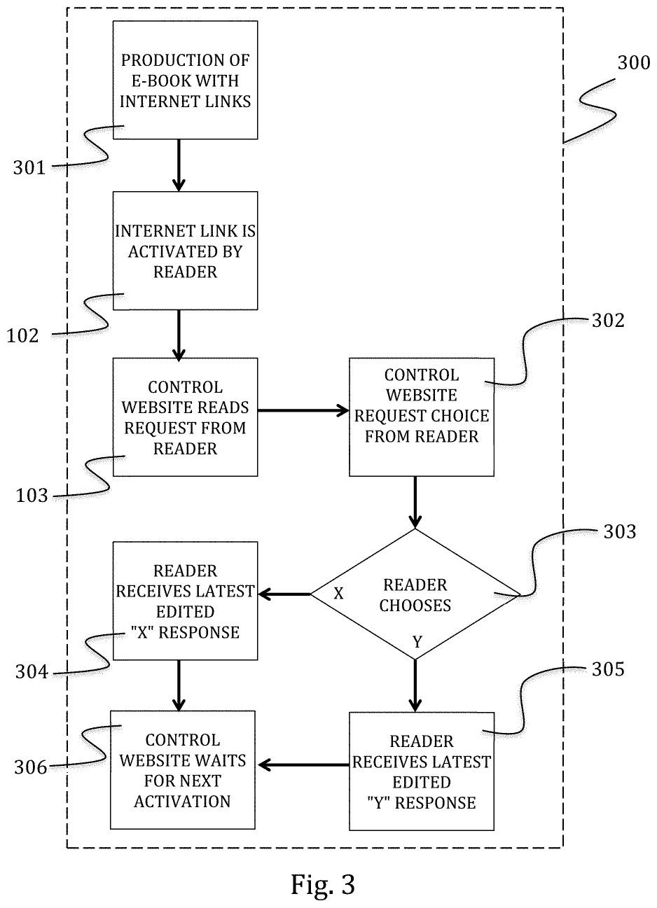

FIG. 3 is a block diagram 300 of a modified Dynamic Editor System 100 to allow a Reader to make a choice. This system preferably works best with e-books 301, but will generally work if the Reader uses another Internet connected device with a camera to activate 102 the Control Website 103. After activation, the Reader may be offered a choice 302 that will be described in the offer. The choice 302 may consist of two, X or Y, or more alternate redirection paths. The Reader may pick a path 303. If Reader picks path X, the latest edited X resdirect 304 may then be delivered. If Reader picks path Y, the latest edited Y redirect 305 may then be delivered. The Control Website 103 may then wait for next activation 306.

FIG. 4 is a working example of a Dynamic Editors QR code 400. The Link ID 403 is “qr99” which may correspond to the footnote number “99” 401 in printed material 101. By focusing the camera of a device with Internet connection (for example, a cell phone) and QR code reading capabilities, the Control Website 103 may then respond to the Request 102. The Control Website 103 in this case is “myeblox.com” 404. The Control Website 103 may be connected to the Link ID 403 as shown in the footnote 402 in FIG. 4.

FIG. 5 shows a working example of a section 500 of a page using the Dynamic Editing System 100 in one embodiment. By focusing the camera of a device with Internet connection and QR code reading capabilities on the QR code 501, the Control Website 103 will respond to the Request and show the information associated with the Link ID associated with Request ID 502, which in this case is “qr2”. The Reader of this patent will then see the information delivered by the latest edited redirect for footnote 2 504 on a Wicklow Terrier. If the Link ID associated with request ID 403 is edited 200 even after this book is published, the Reader of this book will then see new and different information about a Wicklow Terrier and the date and name of the Dynamic Editor will then also appear in the Dynamic Editors QR code 400 and Dynamic Editors imbedded link 402 in this book.

Although the above shows the embodiments of the invention pertaining only to printed material and e-books, it should be understood that they also apply to any recorded materials that can be converted to printed text or an e-book by use of devices such as scanners with original character recognition (ocr), speech recognition, touch tone decoding, just to mention a few. It should be understood that various changes and modifications to the presently preferred embodiments will be apparent to those skilled in the art. Such changes and modifications may be made without departing from the spirit and scope of the invention and without diminishing its attendant advantages.

We claim:

1) A system for changing information accessed by recorded or printed text the system comprising:
creating a body of text having at least one link which is directed to a Dedicated Internet Web site address;
wherein activating the Dedicated Internet Website automatically redirects a user to a second Internet website wherein the second Internet website contains information relative to the recorded or printed material;
wherein the redirection may be continuously changed and updated by a control manager who selects which second Internet website the user is redirected to when the link to the Dedicated Internet Website is activated; and
wherein the second Internet website may be one suggested by a reader of the body of the text published and approved by the control manager.

2) The system for changing information accessed by recorded or printed text of claim 1 wherein the body of text is in an electronic format.

3) The system for changing information accessed by recorded or printed text of claim 1 wherein the general public may suggest to the control manager changes with respect to which second Internet Website that the user is redirected to upon activation of the link of the Dedicated Internet Website.

4) The system for changing information accessed by recorded or printed text of claim 1 wherein the body of the text is an e-book.

5) The system for changing information accessed by recorded or printed text of claim 1 wherein the body of text is printed only in paper and ink format.

6) The system for changing information accessed by recorded or printed text of claim 1 wherein the body of text is recorded as speech.

7) The system for changing information accessed by recorded or printed text of claim 1 wherein the user is given an option between a number of different links to different second Internet Websites after first reaching the Dedicated Internet Website.

8) A system for changing information accessed by recorded or printed text the system comprising:
creating a body of text wherein the body of text has at least one link to a Dedicated Internet Web site address;
wherein activating the Dedicated Internet Website automatically redirects a user to a second Internet website wherein the second Internet website contains information relative to the body of text;
wherein the redirection may be continuously changed and updated by a control manager who selects which second Internet website the user is redirected to when the initial Dedicated Internet Website link is activated;
wherein the second Internet website may be one suggested by a reader of the body of text and approved by the control manager of the Dedicated Internet Website;
wherein the body of text has a single QR code and/or imbedded link which redirects the user to a Dedicated Internet Website; and
wherein the second Internet website is only editable by the control manager and wherein the control manager records changes to all redirects from the Dedicated Internet Website to second Internet website.

9) The system for editing electronic printed text of claim 8 wherein any change to the link to the second Internet website is recorded along with the date and time that change was made.

10) The system for editing electronic printed text of claim 8 wherein any change to the link to the second Internet website is recorded along with the name of the person that suggested that change.

11) The system for editing electronic printed text of claim 8 wherein any deletion to the link to the second Internet website is recorded.

12) A system for changing information accessed by recorded or printed text the system comprising:
creating a body of text wherein the body of text has at least one link to a Dedicated Internet Web site address;
wherein activating the Dedicated Internet Website automatically redirects a user to a second Internet website wherein the second Internet website contains information relative to body of the text;
wherein the redirection may be continuously changed and updated by a control manager who selects which second Internet website the user is redirected to when the link to the Dedicated Internet Website is activated;
wherein the second Internet website may be one suggested by a reader of the body of text and approved by the control manager; and
wherein the body of text has only one QR code and/or imbedded link which links the user to the Dedicated Internet Website which is only editable by the control manager and wherein any editing by the control manager is recorded.

13) The system for editing recorded text of claim 12 wherein the password may be provided to the user via a contest.

14) The system for editing recorded text of claim 12 wherein the password may be provided to the user as part of a game
